(19) United States
(12) Patent Application Publication
(10) Pub. No.: US 2017/0219730 A1
(43) Pub. Date: Aug. 3, 2017

(54) METHOD OF WIDE AZIMUTH PROFILING (WAP)

(71) Applicant: P-Cable 3D Seismic AS, Oslo (NO)

(72) Inventors: Ola Kaas ERIKSEN, Oslo (NO); Sverre Planke, Oslo (NO)

(21) Appl. No.: 15/419,495

(22) Filed: Jan. 30, 2017

(30) Foreign Application Priority Data
Feb. 2, 2016 (NO) 20160158

(51) Int. Cl. G01V 1/34; G01V 1/38

(52) U.S. Cl. CPC G01V 1/345; G01V 1/3808; G01V 2210/165

(57) ABSTRACT

A seismic survey method comprising a vessel, a seismic acquisition system for collecting geophysical seismic data, a marine navigation system for generating positioning data from the location of the vessel and the location of the seismic acquisition system, a seismic data storage engaged with the seismic acquisition system for collecting and storing the seismic data and a seismic data processor engaged with said seismic data storage for seismic processing of the seismic data. The seismic data is acquired along a non-linear acquisition path or sail line. The data consists of CMP lines that follow the non-linear acquisition path. A binning grid covering the CMP lines of the acquired data such that the in-lines follow parallel to the acquisition path and the cross-lines are perpendicular to the in-lines is created. The binning grid comprises a straight portion and a curved portion. Bins for each portion of the binning grid is calculated.

### CROSS-REFERENCE TO RELATED APPLICATIONS

This application claims the benefit of priority to Norwegian Patent Application No. 20160158, filed Feb. 2, 2016. The disclosure of the prior application is hereby incorporated in its entirety by reference.

### FIELD OF THE INVENTION

The invention concerns marine seismic data processing, especially binning and arrangement of 3D seismic data, as set out by the preamble of claim 1.

### BACKGROUND OF THE INVENTION

Imaging of geological structures is important for a number of applications, both industrial and academic. Seismic data acquisition is a survey method which is used both on land and in marine environments. In marine seismic data acquisition, geology of structures underlying a body of water is imaged using one or more surface vessels equipped with one or more acoustic sources and one or more streamer cables.

The source generates energy, called a seismic signal, which travels through the water column in all directions. The portion of the energy that travels downward towards the seafloor and underlying geological structures is partly reflected from the different geological structures in the subsurface. The strength of the reflection is given by the change in acoustic impedance over the reflective surface. The reflected signal that travels upward is recorded by the streamer cables towed behind the surface vessel.

The image of the geology is generated based on the time it takes the seismic signal to travel from the source and down to the reflective surfaces and back up to the streamer cables, the positions of the source and the receivers in the streamer cable, and the speed of sound in the different media the signal travels through. The actual position of the reflection in the subsurface is calculated using a mathematical method based on the acoustic wave equation to migrate the seismic signal to a set of coordinates and depth.

The acquisition setup can consist of one or more energy sources. The dominating type of source for marine seismic surveys is air guns that generate a signal by creating an air bubble from compressed air that collapses in the water column. Other sources can be sparkers, boomers and vibrators. The source can be towed from the same vessel as the streamer cables or from one or more separate source vessels. The source is normally fired at a regular interval, this interval is set based on the receiver distance in the streamer cables, number of receivers, towing speed, source type, target depth and desired data density. When the source is fired it is called a shot.

The streamer cables towed behind marine seismic acquisition vessels contain transducers called hydrophones that transform the seismic signal into electromagnetic signals. The hydrophones are distributed along the cable and are often arranged into groups acting as a single receiver. The number of receivers and the distance between them on the cable will vary between different streamer types and desired data properties. The length of the streamer cables vary from only a few meters long (˜10 m) or even just a point receiver for some high-resolution systems, to several kilometer (up to 12 km or more) long streamers for large systems.

For each shot every receiver records an acoustic record called a trace. Each trace has a common midpoint (CMP) which is the middle point between the source and the receiver and is regarded as the position of the measured reflections in the trace. This will however be subject to corrections later inn the processing for dipping reflectors etc. For systems with longer streamers there are many traces with approximately the same CMP position. The traces can be collated to form what is known as a gather, in this case a CMP gather. The number of traces that make up a gather is referred to as the fold of the gather.

Marine 2D seismic data acquisition makes use of a single towed streamer behind a surface vessel and one or more sources. The data is generally acquired along a linear acquisition path, it can however contain turns. The 2D seismic data acquisition is useful for acquiring regional data covering large areas in a relatively inexpensive way. However, it does have the limitation of only containing information along one line. The result is a single cross section of the subsurface with no spatial information.

2D data is normally processed and arranged as shot points, which are CMP gathers that each have coordinates along a single line. This line can be loaded into interpretation software and visualized as a vertical section showing the cross section of the subsurface. Marine 3D seismic data acquisition utilizes several parallel towed streamers behind a surface vessel and one or more sources. The data is generally acquired along parallel linear lines predefined in a pattern which gives a total coverage of the subsurface. The number and the length of the streamer cables used for 3D acquisition depend on the size of the area to be surveyed and the target to be imaged. The number of streamers might vary from 2 to 24 or more streamers, with length variations from 10 m or less to 12 km or more. The individual distance between the streamers may vary from very short, less than a meter, for some ultra-high-resolution systems, to 100 m or more for some large conventional systems. 3D seismic data acquisition is useful when there is a need for a full three-dimensional overview of the subsurface structure. A 3D data volume gives the ability to view the data not only as vertical sections (cross sections) along or parallel to the acquisition path but also vertical sections perpendicular to the acquisition path and in any other direction. The data can also be viewed from a bird's perspective either as time-slices or as horizons that are interpreted along a reflection surface within the data volume. The three-dimensional nature of the data also makes it possible to collapse the reflected seismic signal more accurately to the actual reflection point during a processing step called migration.

The data processing steps of organizing traces in bins is called “binning”. A bin may contain many traces from source-receiver pairs. Azimuth is angle for a particular source-receiver pair referred as the angle defined between the line along which the source-receiver pair lies and an arbitrarily selected direction such as true north or east. 3D data is normally acquired along linear parallel lines to give as regularly sampled data as possible. This is beneficial when the data is processed and arranged into bins which lie along a regular and rectangular grid. During acquisition, each of the streamers in a 3D system will generate a line of CMP positions similar to that of a 2D system. One swath acquired along one sail-line with a 3D system thus contains the same number of CMP lines as the number of parallel streamers used in the 3D system. However, if more than one source is used in a so-called flip flop shooting setup, each streamer will generate one line of CMP positions per source. In processing, a grid is created over the acquisition area. The quadrangles of this grid are called bins. The size of the bins will determine the horizontal resolution of the data volume and also how many CMP positions (traces) that falls into each bin (the fold of the data). The bins have a length in the in-line direction and a length in the cross-line direction. These lengths can either form square or rectangular bins dependent on the parameters of the acquired data. The in-line direction of a data volume is normally defined as parallel to the acquisition direction, and the cross-line direction perpendicular to the acquisition direction, and in-lines and cross-lines are defined to follow the regular/rectangular grid the data volume is binned onto. The volume consisting of these bins can be loaded into interpretation software where the data can be visualized. The standard way of visualizing the data is in vertical sections along the in-lines and cross-lines, but data can also be visualized along an arbitrary line put in manually. 3D data can also be visualized as time-slices, which is a top view of the volume at a given depth, or as interpreted horizons along reflection surfaces. A 3D view where both in-lines, cross-lines, timeslices and horizons, as well as part of the data volume, can be visualized simultaneously is also common with 3D data.

An acquisition campaign would often benefit from having the ability to acquire both 2D and 3D data to maximize the cost/benefit ratio. An example of this are recent surveys in the Barents Sea (2012 - 2015) where the P-Cable high-resolution 3D seismic system has been used to acquire both high-resolution 3D volumes and regional long lines of data processed as 2D data. In this case the acquisition is based on the high-resolution P-Cable system which consists of several short streamer, in this example 16 streamers, each 25 meter long. The streamers are in this example spaced 12,5 meters apart so the system produces a swath of data for each sail line consisting of 16 parallel CMP lines spaced 6.25 meters apart. This setup produces high-resolution 3D volumes but has a limited daily coverage compared to large conventional 3D systems with up to 24 streamers spaced 100 meters apart. To be able to cover both smaller areas with high-resolution 3D data and larger areas with regional data with the same acquisition system, a non-linear line covering interesting features and wells in a larger regional area was predefined. The vessel towed the P-Cable system and the source along this predefined line, and since the P-Cable system is a 3D system, it produced a swath of 16 CMP lines instead of one CMP line which a common 2D system would.

The data was processed such that all the 16 CMP lines where collapsed together to form a single 2D line. The benefit of this is that the fold becomes very high, which gives a high signal to noise ratio. It is also easier to process and visualize the data. However, the cross line information that the data originally contained got lost. The dataset is really a narrow 3D volume that is acquired along a non-linear acquisition path and by applying a new way of arranging/binning and visualizing seismic data one could benefit from the 3D information that is actually acquired.

FIG. 1 illustrates the problem with processing the narrow 3D volumes which are acquired along a non-linear acquisition path in the same manner as normal 3D datasets, in which the normal 3D data is binned onto a regular/rectangular grid. A long non-linear narrow swath requires a potentially very large grid to allow for this type of binning. This grid contains almost only empty bins which is an impractical solution for several reasons. Because the data in this case is of very high resolution the total number of bins is very large.

Another problem when binning these narrow datasets onto regular grids is how it is visualized in interpretation software where the visualization is based along the in-lines and cross-lines of a regular grid, this problem is shown FIG. 2. To visualize a whole line in this case it is necessary to manually create an arbitrary line, and there would not be a way to easily toggle between the 16 individual lines without making new arbitrary lines each time.

A new way of binning 3D seismic data adapted to long and narrow 3D volumes has therefore been invented. It is intended to be used with the P-Cable 3D seismic system but is not limited to only this way of acquiring 3D seismic data. The method can be utilized with any seismic data acquired through parallel towed streamers or other receivers.

### SUMMARY OF THE INVENTION

The invention is set forth and characterized in the main claim, while the dependent claims describe other characteristics of the invention.

It is thus provided a method for arranging 3D seismic data acquired along a non-linear acquisition path or sail line such that the in-lines follow the non-linear acquisition path and the cross-lines are perpendicular or near to perpendicular to the in-lines, the method comprising: creating a binning grid covering the CMP lines of the acquired data. The binning grid comprises a straight portion and a curved portion; and calculating bins for each portion. The non-linear acquisition path may have any shape and length.

The bins have an in-line number i_{y}, cross-line number iₓ, a width (dy) and a length (dx) and centre coordinates. The width (dy) of the bins is chosen based on desired resolution of the seismic data. A centre line is chosen to define the cross lines and the length (dx) of the bins is calculated by using the distances from the centre coordinates of the bin to the centre coordinate of the two neighboring bins with the same in-line number i_{y}.

In one aspect of the invention the dx(i_{y},iₓ) value for the bin 4 B(i_{y},iₓ) is calculated by adding half the distance between CC(i_{y},iₓ) and CC(i_{y},iₓ−1) given by

$$\frac{\sqrt{{( N ( {i}_{y} , {i}_{x} ) - N ( {i}_{y} , {i}_{x} - 1 ) )}^{2} + {( E ( {i}_{y} , {i}_{x} ) - E ( {i}_{y} , {i}_{x} - 1 ) )}^{2}}}{2}$$

to half the distance between CC(i_{y},iₓ+1) and CC(i_{y},iₓ) given by

$$\frac{\sqrt{{( N ( {i}_{y} , {i}_{x} + 1 ) - N ( {i}_{y} , {i}_{x} ) )}^{2} + {( E ( {i}_{y} , {i}_{x} + 1 ) - E ( {i}_{y} , {i}_{x} ) )}^{2}}}{2}$$

### Wherein:

B(i_{y},iₓ) is bin (4) for cross-line (2) number ix and a in-line (1) number i_{y};
CC(i_{y},iₓ) is centre coordinates for bin B(i_{y},iₓ)
N is the Northing value;
E is the Easting value;

In another aspect of the invention there is provided a seismic survey method comprising; a vessel; a seismic acquisition system for collecting geophysical seismic data; a marine navigation system for generating positioning data from the location of said vessel and the location of said seismic acquisition system; a seismic data storage engaged with the seismic acquisition system for collecting and storing the seismic data; a seismic data processor engaged with said seismic data storage for seismic processing of the seismic data; wherein the seismic data has been acquired along a non-linear acquisition path or sail line. The data consists of CMP lines that follow the non-linear acquisition path. A binning grid covering the CMP lines of the acquired data is created such that the in-lines follow parallel to the acquisition path and the cross-lines are perpendicular or near to perpendicular to the in-lines, the binning grid comprising a straight portion and a curved portion. The bins for each portion of the binning grid are calculated.

In another aspect of the invention there is provided a machine with a readable storage medium using a program of instructions executable by the machine, to perform method of the invention.

### BRIEF DESCRIPTION OF THE DRAWINGS

These and other characteristics of the invention will become clear from the following description of a preferential form of embodiment, given as a non-restrictive example, with reference to the attached schematic drawings, wherein:

FIG. 1: Shows a WAP swath binned onto a rectangular grid in the same manner as conventional 3D data.

FIG. 2: Shows visualization of the problem of a WAP swath that is binned onto a rectangular grid.

FIG. 3a: Shows a vessel towing a 3D seismic acquisition system acquiring a WAP swath of several in-lines along a non-linear acquisition path.

FIG. 3b: Shows WAP swath binned according to the invention.

FIG. 4: Shows section A of FIG. 3b.

FIG. 5: Shows P-Cable acquisition system acquiring a WAP swath that is binned according to the invention.

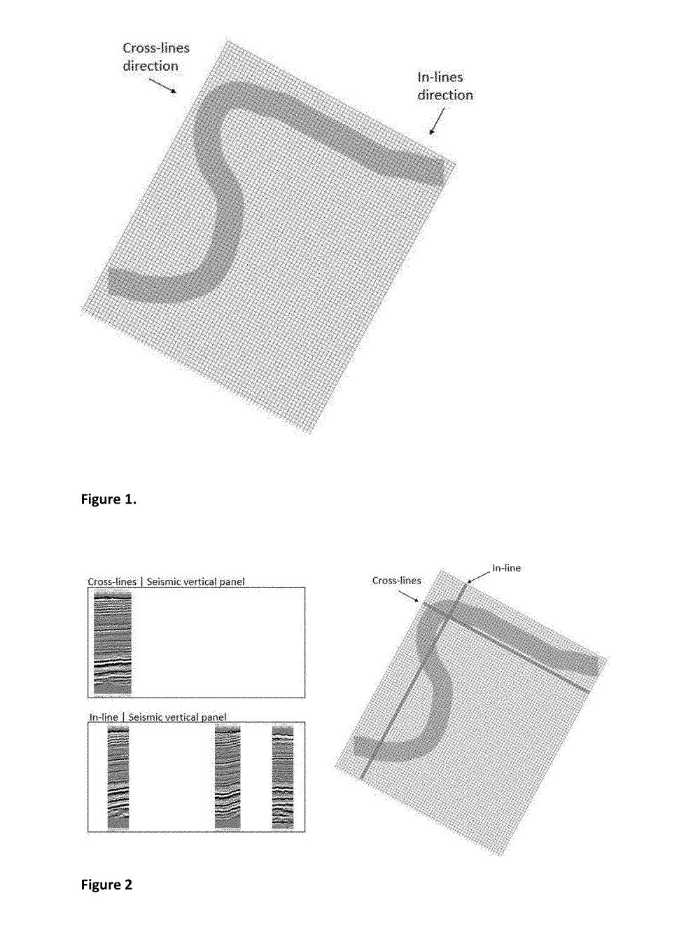

### DETAILED DESCRIPTION OF A PREFERENTIAL EMBODIMENT

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting.

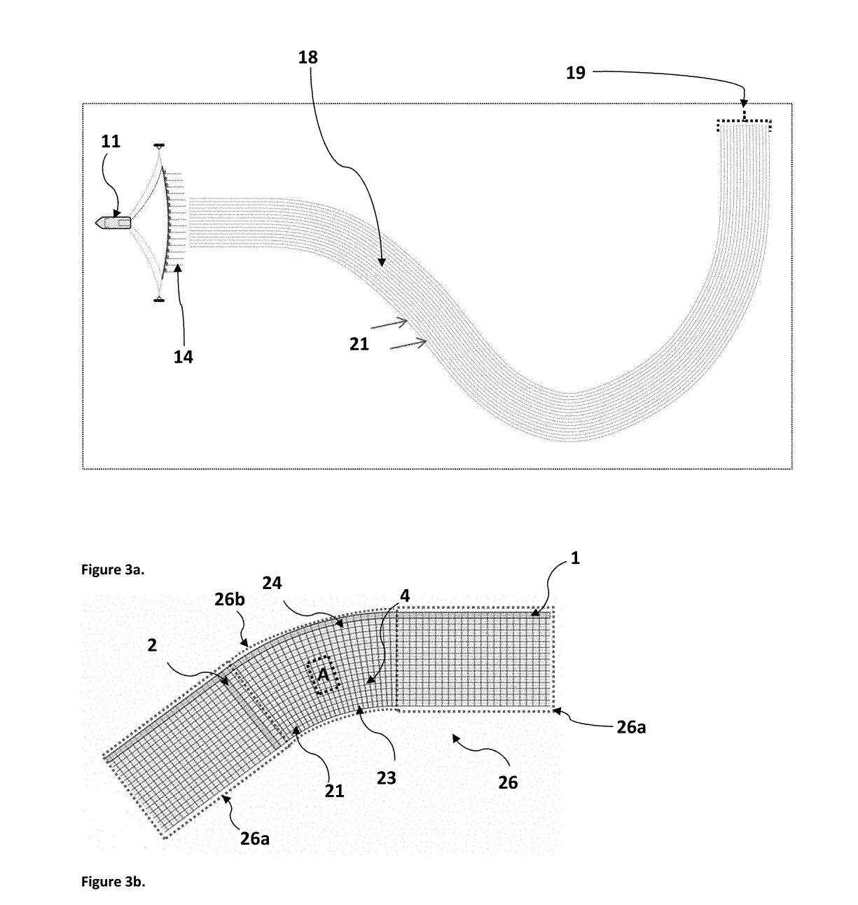

FIG. 3a shows a seismic vessel 11 towing a 3D seismic acquisition system with everal streamers 14 in non-linear WAP swath 18 manner. The WAP swath 18 has a width 19 and consists of several CMP lines 21. The invention provides a method of binning and processing seismic data acquired along a non-linear acquisition path such that the in-lines 1 always are parallel to the acquisition path and the cross-lines 2 are perpendicular to the in-lines 1 at any given point. This is in contrast to the standard method where the in-lines and cross-lines are linear and lie along a regular and rectangular grid.

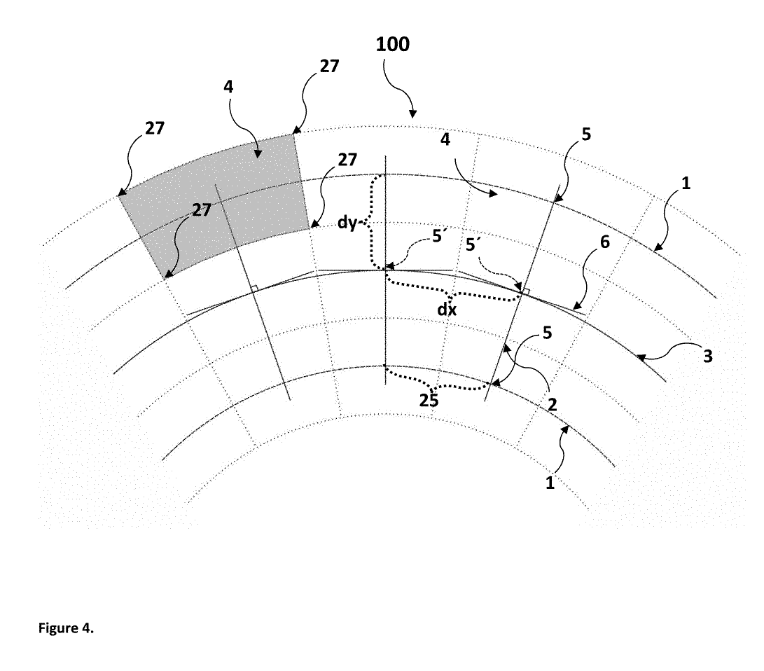

FIG. 4: Shows section A of FIG. 3b. Based on the layout of the acquisition system and desired resolution as shown in FIGS. 3a and 3b, a bin 4 size is chosen. The bin 4 width will typically be equal to the distance between CMP lines 21 created by the individual streamers 14, but is not limited to this width and can be wider or narrower to give the dataset other properties. The bin 4 length may also vary dependent on how many CMP points falls into each bin. The bin 4 length may be shorter, longer or equal to the bin width. Each bin 4 is given a center coordinate. All the centre coordinates 5 of the bins 4 making up a single cross-line lie on a linear line which is normal to the in-lines it crosses at the crossing points. The centre coordinates 5 making up the individual in-lines 1 lie along a line parallel to the acquisition path, this line is not necesserily a linear line. All the individual in-lines 1 are parallel to each other. As such, a binning grid 26 is created which will be rectangular 26a when the acquisition path is linear, and the binning grid 26 will be curved 26b if the acquisition path is curved. In the curved parts of the WAP grid 26b the bin size will not be the same along the individual cross-lines 2. The center bins 4 of the individual cross lines 2 that forms the centre in-line 1 will have the same bin size in both the linear and curved portions of the WAP swath 26, while the “inner” bins 23 taking the shorter path in the curved parts of the grid 26b will be shorter and the “outer” bins 24 taking the longer path in the curved parts of the grid 26b will be longer. The bins along the cross-lines in the linear part of the WAP grid 26a will be approximately equal in size. All the bins will have approximately the same width.

Each CMP point on a CMP line 21 will be assigned to a bin 4, typically the closest one, but not necessarily. The number of CMP's assigned to each bin 4 is defined as the fold of the bin 4. Each bin 4 will typically have an in-line 1 and a cross-line 2 number, a set of coordinates, a bin width (dy) and length (dx) and an azimuth value, among other values.

FIG. 4 is a view of section A of FIG. 3b where the curvature of the bins (4) are exaggerated relative to FIG. 3b. This figure shows the process of binning the WAP data 100. The process of binning the WAP swath data 100, such that the in-lines 1 follow parallel to the acquisition path and the cross-lines 2 lie normal to the inlines 1, is based on a concept where a centre line 3 is defined and used to define the cross-lines 2. The x- and y-direction in the binning of WAP data 100 are defined such that the x-direction is along the in-lines 1, and the y-direction is along the cross-lines 2. The CMP line 21 (shown in FIG. 3a,b) from one of the central streamers may be used as a centre line 3. This centre line 3 may undergo smoothing before a cross-line 2 spacing (distance between cross-lines) dx is chosen. This dx defines the length of the bins 4. Points along the centre line 3 with a spacing of dx are defined as initial centre coordinates 5′ for the line of bins 4 forming the centre in-line in the WAP grid 26. At each of these initial centre coordinates 5′ a tangent 6 of the centre line 3 is calculated. A cross-line 2 is then defined at each of the initial centre coordinates 5′ on the centre line 3 as a linear line that is normal to the centre line 3, hence the calculated tangent 6. Along these cross-lines 2, a number of centre coordinates 5 are defined with spacing, dy. The total number of centre coordinates 5 per cross-line 2 makes the number of in-lines 1 in the grid 26. Both dx and dy is chosen based on the desired properties of the binned dataset. The centre line 3 is first predefined to be able to define the cross-lines 2. Next, the in-lines 1 can be defined based on the centre coordinates 5 on the cross-lines 2. All the in-lines in a WAP swath 100 have the same number of centre coordinates 5 and thus also the same number of bins 4, which is also the number of cross-lines 2 in the WAP grid 26. And all the individual cross-lines 2 have the same number of centre coordinates 5 and thus also the same number of bins 4, which is also the number of in-lines 1 in the WAP grid 26. A WAP grid then consists of n_{y} in-lines 1 and nₓ cross-lines 2 where the in-line 1 numbers i_{y} are ranging from 1 to n_{y}, and the cross-line 2 numbers iₓ are ranging from 1 to nₓ. Each in-line 1 in the WAP binning grid 26 consists of nₓ bins 4 and each cross-line 2 constists of n_{y} bins 4. Each bin 4 have a centre coordinate 5 and belongs to one in-line 1 and one cross-line 2 and thus have an in-line 1 number and a cross-line number 2. All bins 4 with the same in-line 1 number forms an in-line 1 and all bins 4 with the same cross-line 2 number forms a cross-line 2. All the bins 4 in both the in-lines 1 and the cross-lines 2 are numbered sequentially along the line.

When the centre coordinates 5 for all the bins 4 in the WAP binning grid are calculated, a dx value for all the bins 4 will be calculated to define the bin length. The dx values for the initial centre coordinates 5′ of the centre line 3 is chosen based on the desired properties of the binned dataset, but the dx values for the bins forming the other in-lines will where the acquisition path is curved not be the same as for the centre in-line and they may vary along the in-lines 1. In linear parts of the swath the dx value may approximately be the same for all the bins 4 along an individual cross-line 2, however, in the curved parts of the swath, the dx value will vary along the cross-line 2 as illustrated with reference number 25. The dx value for the individual bins 4 is calculated by using the distances from the centre coordinate 5 of the bin to the centre coordinates 5 of the two neighboring bins 4 with the same in-line 1 number. This will give a unique dx value for all the bins 4 except for those forming the centre in-line defined by the centre line 3 used to define the cross-lines 2. This calculation is based on simple Pythagoras and the curved nature of the bins is ignored at bin level and the distances are calculated as straight lines between coordinates of neighboring bins. The centre coordinates 5 of the bins 4 consist of a Northing and an Easting, given that the coordinates are given in the Universal Transverse Mercator coordinate system (UTM). The data is however not limited to be represented by this coordinate system. For easier notation the centre coordinates 5 are now shortened CC, the bins B, the Northing N and the Easting E. They will all be linked to both a cross-line 2 number ix and a in-line 1 number i_{y} like this CC(i_{y},iₓ). The dx(i_{y},iₓ) value for the bin 4 B(i_{y},iₓ) is calculated by adding half the distance between CC(i_{y},iₓ) and CC(i_{y},iₓ−1) given by

$$\frac{\sqrt{{( N ( {i}_{y} , {i}_{x} ) - N ( {i}_{y} , {i}_{x} - 1 ) )}^{2} + {( E ( {i}_{y} , {i}_{x} ) - E ( {i}_{y} , {i}_{x} - 1 ) )}^{2}}}{2}$$

to half the distance between CC(i_{y},iₓ+1) and CC(i_{y},iₓ) given by

$$\frac{\sqrt{{( N ( {i}_{y} , {i}_{x} + 1 ) - N ( {i}_{y} , {i}_{x} ) )}^{2} + {( E ( {i}_{y} , {i}_{x} + 1 ) - E ( {i}_{y} , {i}_{x} ) )}^{2}}}{2}$$

The bin corners 27 are simply defined as the crossing point between two lines where the first line is defined as a linear line between the middle point between CC(i_{y},iₓ) and CC(i_{y}+1,iₓ) and the middle point between CC(i_{y},iₓ+1) and CC(i_{y}+1,iₓ+1), and the second line is defined as a linear line between the middle point between CC(i_{y},iₓ) and CC(i_{y},iₓ+1) and the middle point between CC(i_{y}+1,iₓ) and CC(i_{y}+1,iₓ+1). This corner will then be the corner between the four bins 4 B(i_{y},iₓ), B(i_{y},iₓ+1), B(i_{y}+1, iₓ) and B(i_{y}+1, iₓ+1).

A complete binning grid with coordinates for both the centre coordinates 5 of the bins 4, and the corners 27 giving the bins a physical exstent making it possible to decide which traces belong to which bins 4, is now calculated.

The cross-lines 2 are defined based on the chosen centre line 3, which is a smoothened version of the CMP line created by the central streamer in the acquisition system. However, if the centre line 3 still is too uneven and the “inner” parts of the cross-lines 2 defined to be normal to the centre line 3 are crossing each other in curved parts of the swath 18, a negative dx value will be calculated for some bins 4. This will not be accepted and more smoothing will be applied to the centre line 3 until a positive dx is obtained for all bins 4. Or the trace can be deleted from the binning process.

When the WAP binning grid 26 is complete, all the traces are assigned to the bin 4 they fall within based on their CMP position. If some traces do not fall into any bin 4 but falls outside the WAP binning grid 26, the WAP binning grid 26 is either recalculated using a modified centre line 3 or the trace is simply assigned to the closest bin 4. This decision will be made based on the number of bins 4 that fall outside the WAP binning grid 26 and how far outside the WAP binning grid 26 they are located.

Further processing of the WAP data can be performed either by means of 3D processing or 2D processing. Typically, noise removal and smoothing of the data will benefit from data in three dimensions, and for wide swaths or in cases where there is more than one adjacent swath a 3D migration could even be conducted. If it is decided to not utilize the 3D information in the dataset, all or some of the bins with the same cross-line number can be stacked together such that the swath becomes a single in-line which will then be a 2D line. The benefit is that the number of traces stacked together will be relatively large and will give a high signal to noise ratio. The processing steps may further include, but is not limited to; demultiplexing, geometry corrections, editing, amplitude corrections, frequency filters, deconvolution, CMP-sorting, velocity analysis, NMO/DMO-corrections, stacking, migration or any other step known in the seismic processing art.

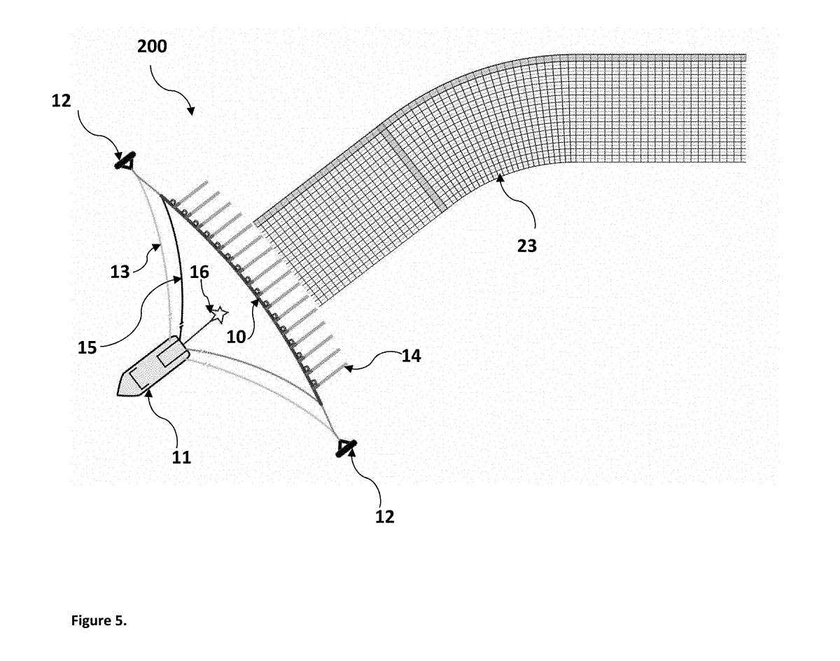

The seismic data may be a data acquired by a P-Cable high resolution 3D seismic acquisition system. This system makes it possible to collect many seismic profiles simultaneously in a manner which is simpler than when applying conventional techniques. This system is shown in FIG. 5 in more detail. The system 200 is based around a cross cable 10. This is a cable which is towed perpendicular to the sailing direction of the vessel 11 and is suspended in the water by two paravanes 12. The two is paravanes 12 are towed by the vessel 11 from two tow ropes 13. Several streamers 14 with a short mutual distance are attached at the cross cable 10, normally between 3 and 15 meters dependent of system configuration. These distances between the streamer should however not be seen as a limitation for streamer spacing. The signal from these streamers 14 are digitized in a digitizing unit for each streamer 14 in the water before it is transferred to the acquisition unit on the vessel through the cross cable 10 and a single signal cable 15 on either or both sides of the system 200, normally the starboard side. The fact that the signals from all the individual streamers 14 are transferred through the cross cable 10 and then through the same signal cable 15, instead of through a separate signal cable for each streamer 14 as is the case for large conventional 3D systems, allow the streamers 14 to be attached with such a short streamer distance. Due to this short streamer spacing the streamers 14 are relatively short, typically between 12,5 and 100 meters, in contrast to conventional systems where streamers of 10 kilometer length or longer is not uncommon. A seismic source 16 is deployed straight behind the vessel 11 inside the triangle formed by the cross cable 10 and the two tow ropes 13.

The streamer 14 layout with closely spaced streamers gives the ability to acquire data with very closely spaced CMP lines wich again allow the data to be binned with a small bin size giving data with very high horizontal data. Combined with high frequency sources a dataset of very high resolution can be abtained.

Another advantage for this data collection system is that both WAP data and 3D data acquisition have the same configuration. This allows both regional and target specific acquisition in the same survey without modification to the acquisition setup. The WAP seismic data acquired with this system also have more potential than conventional 2D seismic data because it is a narrow 3D cube. This is also a relatively compact and lightweight system that can be operated from a variety of vessels including smaller vessel not purpose built for seismic operations. This again leads to a daily operational cost that is lower than for large conventional 3D operations which utilizes large purpose built vessels to operate the large systems with long streamers and large paravanes. A WAP swath can be acquired with this system for a cost approximately the same as that of a regular 2D line, but with the added benefit of 3D information within the WAP swath, and the ability to acquire smaller proper 3D volumes at specific targets with the same system without modifications.

It should be understood that a computer program is used to visualize, analyse and process the seismic data accordingly to the invention.

While the present invention has been described with reference to the illustrated embodiment, it should be understood that numerous changes exist in the details of procedures for accomplishing the desired results, but these shall remain within the field and scope of the invention.

1. A method for arranging seismic data acquired along a non-linear acquisition path or sail line such that the in-lines follow the non-linear acquisition path and cross-lines are perpendicular, or near to perpendicular, to the in-lines, the method comprising:
creating a binning grid covering the CMP lines of the acquired data, wherein the binning grid comprises a straight portion and a curved portion; and
calculating bins for each portion.

2. The method according to claim 1, wherein the bins have an in-line number i_{y}, cross-line number iₓ, a width (dy) and a length (dx) and centre coordinates.

3. The method according to claim 2, wherein the width (dy) of the bins is chosen based on desired resolution of the seismic data.

4. The method according to claim 2, wherein a centre line is chosen to define the cross lines.

5. The method according to claim 2, wherein the length (dx) of the bins is calculated by using the distances from the centre coordinates of the bin to the centre coordinate of the two neighboring bins with the same in-line number nx.

6. The method according to claim 5, wherein the dx(i_{y},iₓ) value for the bin 4 B(i_{y},iₓ) is calculated by adding half the distance between CC(i_{y},iₓ) and CC(i_{y},iₓ−1) given by
$$\frac{\sqrt{{( N ( {i}_{y} , {i}_{x} ) - N ( {i}_{y} , {i}_{x} - 1 ) )}^{2} + {( E ( {i}_{y} , {i}_{x} ) - E ( {i}_{y} , {i}_{x} - 1 ) )}^{2}}}{2}$$
to half the distance between CC(i_{y},iₓ+1) and CC(i_{y},iₓ) given by
$$\frac{\sqrt{{( N ( {i}_{y} , {i}_{x} + 1 ) - N ( {i}_{y} , {i}_{x} ) )}^{2} + {( E ( {i}_{y} , {i}_{x} + 1 ) - E ( {i}_{y} , {i}_{x} ) )}^{2}}}{2}$$
Wherein:
B(i_{y},iₓ) is bin for cross-line number iₓ and a in-line number i_{y};
CC(i_{y}, iₓ) is centre coordinates for bin B(i_{y},iₓ)
N is the Northing value;
E is the Easting value;

7. The method according to claim 1, wherein the non-linear acquisition path may have any shape and length.

8. A seismic survey method comprising;
a vessel; a seismic acquisition system for collecting geophysical seismic data; a marine navigation system for generating positioning data from the location of said vessel and the location of said seismic acquisition system; a seismic data storage engaged with the seismic acquisition system for collecting and storing the seismic data; a seismic data processor engaged with said seismic data storage for seismic processing of the seismic data; wherein the seismic data has been acquired along a non-linear acquisition path or sail line which consists of in-lines that follow the non-linear acquisition path and cross-lines that are perpendicular to the in-lines;
creating a binning grid covering the CMP lines of the acquired data, the binning grid comprising a straight portion and a curved portion; and calculating bins for each portion.

9. A machine with a readable storage medium using a program of instructions executable by the machine, to perform the method of claim 1.
